(19) United States
(12) Patent Application Publication
(10) Pub. No.: US 2013/0267194 A1
(43) Pub. Date: Oct. 10, 2013

(54) Method and System for Notifying a Remote Facility of an Accident Involving a Vehicle

(71) Applicant: American Vehicular Sciences LLC, Frisco, TX (US)

(72) Inventor: DAVID S BREED, MIAMI BEACH, FL (US)

(21) Appl. No.: 13/911,734

(22) Filed: Jun. 6, 2013

Related U.S. Application Data
(63) Continuation-in-part of application No. 13/270,353, filed on Oct. 11, 2011.
Application No. 13/270,353 is a continuation-in-part of application No. 11/947,028, filed on Nov. 29, 2007, now Pat. No. 8,035,508.
Application No. 11/947,028 is a continuation-in-part of application No. 10/940,881, filed on Sep. 13, 2004, now Pat. No. 7,663,502.
Application No. 10/940,881 is a continuation-in-part of application No. 10/457,238, filed on Jun. 9, 2003, now Pat. No. 6,919,803.
Application No. 10/940,881 is a continuation-in-part of application No. 10/931,288, filed on Aug. 31, 2004, now Pat. No. 7,164,117.
Application No. 11/947,028 is a continuation-in-part of application No. 11/278,979, filed on Apr. 7, 2006, now Pat. No. 7,386,372.
Application No. 11/278,979 is a continuation-in-part of application No. 10/931,288, filed on Aug. 31, 2004, now Pat. No. 7,164,117.
Application No. 11/947,028 is a continuation-in-part of application No. 11/380,574, filed on Apr. 27, 2006, now Pat. No. 8,159,338.
Application No. 11/380,574 is a continuation-in-part of application No. 10/931,288, filed on Aug. 31, 2004, now Pat. No. 7,164,117.
Application No. 11/947,028 is a continuation-in-part of application No. 11/619,863, filed on Jan. 4, 2007.
Application No. 11/619,863 is a continuation-in-part of application No. 10/931,288, filed on Aug. 31, 2004, now Pat. No. 7,164,117.
Application No. 11/947,028 is a continuation-in-part of application No. 11/755,199, filed on May 30, 2007, now Pat. No. 7,911,324.
Application No. 11/755,199 is a continuation-in-part of application No. 11/843,932, filed on Aug. 23, 2007, now Pat. No. 8,310,363.
Application No. 11/843,932 is a continuation-in-part of application No. 11/865,363, filed on Oct. 1, 2007, now Pat. No. 7,819,003.
(60) Provisional application No. 60/387,792, filed on Jun. 11, 2002.

(51) Int. Cl. H04W 4/22

(52) U.S. Cl. CPC H04W 4/22
USPC 455/404.2

(57) ABSTRACT

Method and system for notifying a remote facility of a vehicular accident includes obtaining information about the accident using a crash sensor system on the vehicle, obtaining information about position of the vehicle using a position determining system, obtaining information about occupancy of the vehicle by animate occupants using an occupant sensing system on the vehicle, generating at least one data packet derived from information obtained by the crash sensor system and information obtained by the occupant sensing system and directing the data packet(s), using a communications system on the vehicle, from the vehicle directly to the remote facility without involving an intermediary. The information about position of the vehicle obtained by the position determining system is provided to the remote facility to be associated with the data packet(s).

### CROSS REFERENCE TO RELATED APPLICATIONS

This application is a continuation-in-part (CIP) of U.S. patent application Ser. No. 13/270,353 filed Oct. 11, 2011 which is a CIP of U.S. patent application Ser. No. 11/947,028 filed Nov. 29, 2007, now U.S. Pat. No. 8,035,508, which is

1. a CIP of U.S. patent application Ser. No. 10/940,881 filed Sep. 3, 2004, now U.S. Pat. No. 7,663,502, which is:
A. a CIP of U.S. patent application Ser. No. 10/457,238 filed Jun. 9, 2003, now U.S. Pat. No. 6,919,803, which claims priority under 35 U.S.C. §119(e) of U.S. provisional patent application Ser. No. 60/387,792 filed Jun. 11, 2002, now expired;
B. a CIP of U.S. patent application Ser. No. 10/931,288 filed Aug. 31, 2004, now U.S. Pat. No. 7,164,117;

2. a CIP of U.S. patent application Ser. No. 11/278,979 filed Apr. 7, 2006, now U.S. Pat. No. 7,386,372, which is a CIP of U.S. patent application Ser. No. 10/931,288 filed Aug. 31, 2004, now U.S. Pat. No. 7,164,117;

3. a CIP of U.S. patent application Ser. No. 11/380,574 filed Apr. 27, 2006 which is a CIP of U.S. patent application Ser. No. 10/931,288 filed Aug. 31, 2004, now U.S. Pat. No. 7,164,117;

4. a CIP of U.S. patent application Ser. No. 11/619,863 filed Jan. 4, 2007 which is a CIP of U.S. patent application Ser. No. 10/931,288 filed Aug. 31, 2004, now U.S. Pat. No. 7,164,117;

5. a CIP of U.S. patent application Ser. No. 11/755,199 filed May 30, 2007, now U.S. Pat. No. 7,911,324;

6. a CIP of U.S. patent application Ser. No. 11/843,932 filed Aug. 23, 2007; and

7. a CIP of U.S. patent application Ser. No. 11/865,363 filed Oct. 1, 2007, now U.S. Pat. No. 7,819,003.

The present invention is also related to U.S. patent application Ser. No. 11/927,934, filed Oct. 30, 2007, now abandoned.

All of the foregoing patent application and all references, patents and patent applications that are referred to below are incorporated by reference in their entirety as if they had each been set forth herein in full.

### FIELD OF THE INVENTION

The present invention relates generally to methods and systems for communicating directly from vehicles to emergency personnel without intermediaries.

### BACKGROUND OF THE INVENTION

Background of the invention is found in U.S. Pat. No. 6,919,803.

Definitions in the Background of the Invention section of any of the above-mentioned applications are also generally, but not restrictively, applicable herein.

Automatic collision notification systems (ACN) typically operate through an intermediary such as, for example, ONSTAR® and Splitsecond™. A major concern of these systems is that they require an intermediary, i.e., a person that talks to the driver or other vehicle occupant after a crash involving the vehicle, and also a subscription to provide money to fund the intermediary. Such subscription-based services require the vehicle owner to continuously pay for the service. Thus, in many cases vehicle owners are denied the benefit of the service if they fail to renew their subscriptions. These subscription-based services are justified by having the vehicle owner communicate with the intermediary who then communicates with the 911 operator or other EMS provider.

### SUMMARY OF THE INVENTION

A method for notifying a remote facility of an accident involving a vehicle in accordance with the invention includes obtaining information about the accident using a crash sensor system on the vehicle, obtaining information about position of the vehicle using a position determining system, obtaining information about occupancy of the vehicle by animate occupants using an occupant sensing system on the vehicle, generating at least one data packet derived from information obtained by the crash sensor system and information obtained by the occupant sensing system and directing each data packet, using a communications system on the vehicle, from the vehicle directly to the remote facility without involving an intermediary. The information about position of the vehicle obtained by the position determining system is provided to the remote facility to be associated with the data packet(s). Each or all of the data packets may be repeatedly directed to the remote facility until reception by the remote facility is acknowledged.

The remote facility is a facility that determines response personnel and equipment to dispatch to the site of the accident and that dispatches the appropriate personnel and equipment, e.g., an emergency dispatch center operated by a municipality and that directly commands police, fire and emergency medical technicians (EMTs) to the accident site. The remote facility is distinguished from the intermediary manned operations center of an emergency service, such as ONSTAR®, that has people and/or automated systems for processing information from the vehicle and, in turn, contacting the remote facility such as an emergency dispatch center. The invention therefore eliminates this intermediary.

In one embodiment, it is possible to integrate the crash sensor system, the occupant sensing system and the communications system into a single unit that can be installed onto the vehicle during manufacture of the vehicle and/or as an aftermarket product installed after manufacture of the vehicle.

It is possible to establish a bi-directional communications channel for voice between the vehicle and the remote facility using the communications system. It is also possible to record sounds using at least one microphone in the vehicle, which may be part of the occupant sensing system, or part of a smartphone coupled to the occupant sensing system, and include recorded sounds in one or more of the data packets.

When the position determining system is arranged on the vehicle, the position of the vehicle determined by the position determining system is included in one or more of the data packets.

It is possible to obtain secondary location information from a navigation system on the vehicle, in which case, the secondary position information obtained from the navigation system is included in one or more of the data packets. The navigation system may be configured to update the secondary position information at periodic time intervals, store the most recent secondary position information and then provide the stored most recent secondary position information to be included in one or more of the data packets.

It is also possible to obtain information about airbag deployment from an airbag system, in which case, the airbag deployment information obtained from the airbag system is included in one or more of the data packets.

The information about the accident from the crash sensor system, the information about position of the vehicle from the position determining system, and the information about occupancy of the vehicle from the occupant sensing system may be provided to an on-board processor that generates the data packets from the provided information.

A vehicular system for notifying a remote facility of an accident involving the vehicle in accordance with the invention includes a crash sensor system that obtains information about the accident, a position determining system that obtains information about position of the vehicle, an occupant sensing system in the vehicle that obtains information about occupancy of the vehicle by animate occupants, and a communications system that directs at least one data packet derived from the information obtained by the crash sensor system, the information obtained by the position determining system and the information obtained by the occupant sensing system from the vehicle directly to the remote facility without involving an intermediary. The communications system may be configured to establish a bi-directional communications channel for voice between the vehicle and the remote facility.

Additional embodiments may include at least one microphone that records sounds, in which case, the communications system is coupled to the at least one microphone and the sounds recorded by the at least one microphone are included in one or more of the data packets. A navigation system may be provided in the vehicle and configured to obtain secondary position information, in which case, the communications system is coupled to the navigation system and the secondary position information obtained by the navigation system is included in one or more of the data packets. The navigation system may also be configured to update the secondary position information at periodic time intervals, store the most recent secondary position information and then provide the stored most recent secondary position information to be included in one or more of the data packets. An airbag system that obtains information about airbag deployment may be provided in the vehicle, in which case, the communications system is coupled to the airbag system so that the airbag deployment information obtained by the airbag system being included in one or more of the data packets. A processor may be interposed between the communications system and each of crash sensor system, the position determining system and the occupant sensing system, which processor is configured to generate the data packets from the provided information.

### BRIEF DESCRIPTION OF THE DRAWINGS

The following drawings are illustrative of embodiments of the system developed or adapted using the teachings of at least one of the inventions disclosed herein and are not meant to limit the scope of the invention as encompassed by the claims.

FIG. 1 is a cutaway view of a vehicle showing possible mounting locations for vehicle interior temperature, humidity, carbon dioxide, carbon monoxide, alcohol or other chemical or physical property measuring sensors.

FIG. 2 is a schematic of a vehicle with several accelerometers and/or gyroscopes at preferred locations in the vehicle.

FIG. 3 is a schematic showing the use of a cell phone or PDA for monitoring a vehicle in accordance with the invention.

FIG. 4 is a schematic showing an alternate method of using of a cell phone or PDA to monitor the person carrying the cell phone or PDA.

FIG. 5 is a schematic view of overall telematics system in accordance with the invention.

FIG. 6 is a flow chart showing use of a smartphone in an embodiment of a method of the invention.

### DETAILED DESCRIPTION OF THE INVENTION

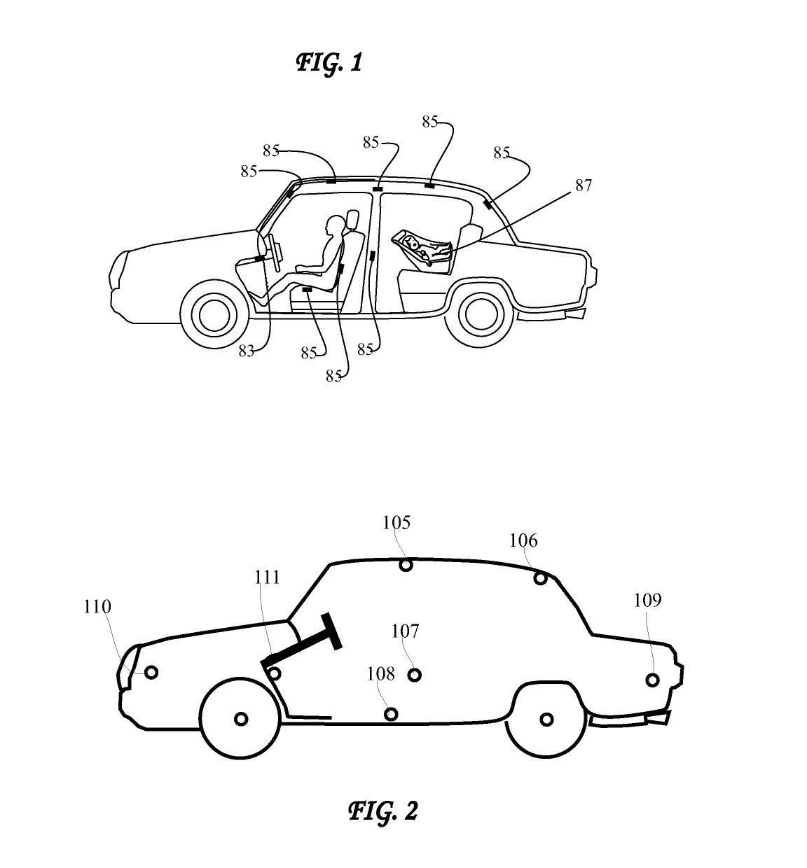

Referring to the accompanying drawings wherein like reference numbers refer to the same or similar elements, FIG. 1 illustrates a vehicle passenger compartment, and an engine compartment, with multiple SAW or RFID temperature sensors 85. SAW temperature sensors can be distributed throughout the passenger compartment, such as on the A-pillar, on the B-pillar, on the steering wheel, on the seat, on the ceiling, on the headliner, and on the windshield, rear and side windows and generally in the engine compartment. These sensors, which can be independently coded with different IDs and/or different delays, can provide an accurate measurement of the temperature distribution within the vehicle interior. RFID switches can also be used to isolate one device from another. Such a system can be used to tailor the heating and air conditioning system based on the temperature at a particular location in the passenger compartment. If this system is augmented with occupant sensors, then the temperature can be controlled based on seat occupancy and the temperature at that location. If the occupant sensor system is based on ultrasonics, then the temperature measurement system can be used to correct the ultrasonic occupant sensor system for the speed of sound within the passenger compartment. Without such a correction, the error in the sensing system can be as large as about 20 percent.

The SAW temperature sensors 85 provide the temperature at their mounting location to a processor unit 83 via an interrogator with the processor unit 83 including appropriate control algorithms for controlling the heating and air conditioning system based on the detected temperatures. The processor unit 83 can control, e.g., which vents in the vehicle are open and closed, the flow rate through vents and the temperature of air passing through the vents. In general, the processor unit 83 can control whatever adjustable components are present or form part of the heating and air conditioning system.

All of the elements of the system which adjusts or controls the vehicle components in any of the embodiments described herein, i.e., the sensors, processing unit and reactive system which is controlled by the processing unit based on the data sensed by the sensors, can be arranged within the vehicle. They could be fixed to the frame of the vehicle, and/or arranged in an interior defined by the frame, with the sensor assemblies (the sensor and wireless transmission component associated therewith) fixed relative to the processor unit or receiver which contains the antenna capable of receiving the signals being transmitted wirelessly from the wireless transmission component of the sensor assemblies. In some embodiments, the sensor assemblies are arranged on parts of the vehicle which are not fixed to the frame or fixed relative to the processor unit or receiver, such as on the tires, but in other embodiments, the sensor assemblies are arranged only on parts fixed to the frame. This fixed relationship between the sensor assemblies and the receiver(s) associated with the processing unit allows for proper positioning of the receivers to communicate with all designated sensor assemblies.

In FIG. 1, a child seat 87 is illustrated on the rear vehicle seat. The child seat 87 can be fabricated with one or more RFID tags or SAW tags (not shown). The RFID and SAW tag(s) can be constructed to provide information on the occupancy of the child seat, i.e., whether a child is present, based on the weight, temperature, and/or any other measurable parameter. Also, the mere transmission of waves from the RFID or SAW tag(s) on the child seat 87 would be indicative of the presence of a child seat. The RFID and SAW tag(s) can also be constructed to provide information about the orientation of the child seat 87, i.e., whether it is facing rearward or forward. Such information about the presence and occupancy of the child seat and its orientation can be used in the control of vehicular systems, such as the vehicle airbag system or heating or air conditioning system, especially useful when a child is left in a vehicle. In this case, a processor would control the airbag or HVAC system and would receive information from the RFID and SAW tag(s) via an interrogator.

SAW sensors also have applicability to various other sectors of the vehicle, including the powertrain, chassis, and occupant comfort and convenience. For example, SAW and RFID sensors have applicability to sensors for the powertrain area including oxygen sensors, gear-tooth Hall effect sensors, variable reluctance sensors, digital speed and position sensors, oil condition sensors, rotary position sensors, low pressure sensors, manifold absolute pressure/manifold air temperature (MAP/MAT) sensors, medium pressure sensors, turbo pressure sensors, knock sensors, coolant/fluid temperature sensors, and transmission temperature sensors.

SAW sensors for chassis applications include gear-tooth Hall effect sensors, variable reluctance sensors, digital speed and position sensors, rotary position sensors, non-contact steering position sensors, and digital ABS (anti-lock braking system) sensors. In one implementation, a Hall Effect tire pressure monitor comprises a magnet that rotates with a vehicle wheel and is sensed by a Hall Effect device which is attached to a SAW or RFID device that is wirelessly interrogated. This arrangement eliminates the need to run a wire into each wheel well.

FIG. 2 illustrates the placement of a variety of sensors, primarily accelerometers and/or gyroscopes, which can be used to diagnose the state of the vehicle itself. Sensor 105 can be located in the headliner or attached to the vehicle roof above the side door. Typically, there can be two such sensors one on either side of the vehicle. Sensor 106 is shown in a typical mounting location midway between the sides of the vehicle attached to or near the vehicle roof above the rear window. Sensor 109 is shown in a typical mounting location in the vehicle trunk adjacent the rear of the vehicle. One, two or three such sensors can be used depending on the application. If three such sensors are used, preferably one would be adjacent each side of vehicle and one in the center. Sensor 107 is shown in a typical mounting location in the vehicle door and sensor 108 is shown in a typical mounting location on the sill or floor below the door. Sensor 110, which can be also multiple sensors, is shown in a typical mounting location forward in the crush zone of the vehicle. Finally, sensor 111 can measure the acceleration of the firewall or instrument panel and is located thereon generally midway between the two sides of the vehicle. If three such sensors are used, one would be adjacent each vehicle side and one in the center. An IMU would serve basically the same functions.

In general, sensors 105-111 provide a measurement of the state of the vehicle, such as its velocity, acceleration, angular orientation or temperature, or a state of the location at which the sensor is mounted. Thus, measurements related to the state of the sensor would include measurements of the acceleration of the sensor, measurements of the temperature of the mounting location as well as changes in the state of the sensor and rates of changes of the state of the sensor. As such, any described use or function of the sensors 105-111 above is merely exemplary and is not intended to limit the form of the sensor or its function. Thus, these sensors may or may not be SAW or RFID sensors and may be powered or unpowered and may transmit their information through a wire harness, a safety or other bus or wirelessly.

Each sensor 105-111 may be single axis, double axis or triaxial accelerometers and/or gyroscopes typically of the MEMS type. One or more can be IMUs. These sensors 105-111 can either be wired to the central control module or processor directly wherein they would receive power and transmit information, or they could be connected onto the vehicle bus or, in some cases, using RFID, SAW or similar technology, the sensors can be wireless and would receive their power through RF from one or more interrogators located in the vehicle. In this case, the interrogators can be connected either to the vehicle bus or directly to control module. Alternately, an inductive or capacitive power and/or information transfer system can be used.

Some of the inventions herein relate generally to telematics and the transmission of information from a vehicle to one or more remote sites which can react to the position or status of the vehicle and/or occupant(s) or contents therein.

Initially, sensing of the occupancy of the vehicle and the optional transmission of this information, which may include images, to remote locations will be discussed. This entails obtaining information from various sensors about the occupants in the passenger compartment of the vehicle, for example, e.g., the number of occupants, their type and their motion, if any. Then, the concept of a low cost automatic crash notification system will be discussed. Next, a diversion into improvements in cell phones will be discussed followed by a discussion of trapped children and how telematics can help save their lives. Finally, the use of telematics with non-automotive vehicles will round out this section.

The use of telematics is included with a discussion of general vehicle diagnostic methods with the diagnosis being transmittable via a communications system to the remote locations is discussed in the parent '363 application. The diagnostics section includes an extensive discussion of various sensors for use on the vehicle to sense different operating parameters and conditions of the vehicle is provided. All of the sensors discussed herein can be coupled to a communications system enabling transmission of data, signals and/or images to the remote locations, and reception of the same from the remote locations. Many transmission modes exist including cellular phone systems, satellite communications and the Internet. The Internet systems can be broken into two types, those that are available only at particular “hot-spots” and the use of ubiquitous internet. The use of ubiquitous internet is believed to be unique to the inventions herein as the inventor may have been the first to recognize that ubiquitous internet would become available and can be counted on to provide the sole system for communication from various vehicles including automobiles, trucks and truck trailers, storage tanks and shipping containers replacing all other communication systems. Their vision is now being realized through such systems as WiMAX.

The cellular phone system, ubiquitous internet, or other telematics communication device, is shown schematically in FIG. 2 of the parent '363 application and outputs to an antenna. The phone system or telematics communication device 34 can be coupled to the vehicle interior monitoring system in accordance with any of the embodiments disclosed herein and serves to establish a communications channel with one or more remote assistance facilities, such as an EMS facility or dispatch facility from which emergency response personnel are dispatched. The telematics system can also be a satellite-based system such as provided by Skybitz.

In the event of an accident, the electronic system associated with the telematics system interrogates the various interior monitoring system memories in processor 20 and can arrive at a count of the number of occupants in the vehicle, if each seat is monitored, and, in more sophisticated systems, even makes a determination as to whether each occupant was wearing a seatbelt and if he or she is moving after the accident, and/or the health state of one or more of the occupants as described above, for example. The telematics communication system then automatically notifies an EMS operator and the information obtained from the interior monitoring systems is forwarded in that notification or subsequently, so that a determination can be made as to the number of ambulances and other equipment to send to the accident site. Vehicles having the capability of notifying EMS in the event one or more airbags deployed are now in service but are not believed to use any of the innovative interior monitoring systems described herein. Such vehicles will also have a system, such as the global positioning system, which permits the vehicle to determine its location and to forward this information to the EMS operator.

In relation to this aspect, see the discussion above of the schematic shown in FIG. 61 of the parent '363 application.

Once an occupying item has been located in a vehicle, or any object outside of the vehicle, the identification or categorization information along with an image, including an IR or multispectral image, or icon of the object can be sent via a telematics channel to a remote location. A passing vehicle, for example, can send a picture of an accident or a system in a vehicle that has had an accident can send an image of the occupant(s) of the vehicle to aid in injury assessment by the EMS team.

Although in most if not all of the embodiments described above, it has been assumed that the transmission of images or other data from the vehicle to the EMS or other off-vehicle (remote) site is initiated by the vehicle, this may not always be the case and in some embodiments, provision is made for the off-vehicle site to initiate the acquisition and/or transmission of data including images from the vehicle. Thus, for example, once an EMS operator knows that there has been an accident, he or she can send a command to the vehicle to control components in the vehicle to cause the components send images and other data so that the situation can be monitored by the operator or other person. The capability to receive and initiate such transmissions can also be provided in an emergency vehicle such as a police car or ambulance. In this manner, for a stolen vehicle situation, the police officer, for example, can continue to monitor the interior of the stolen vehicle.

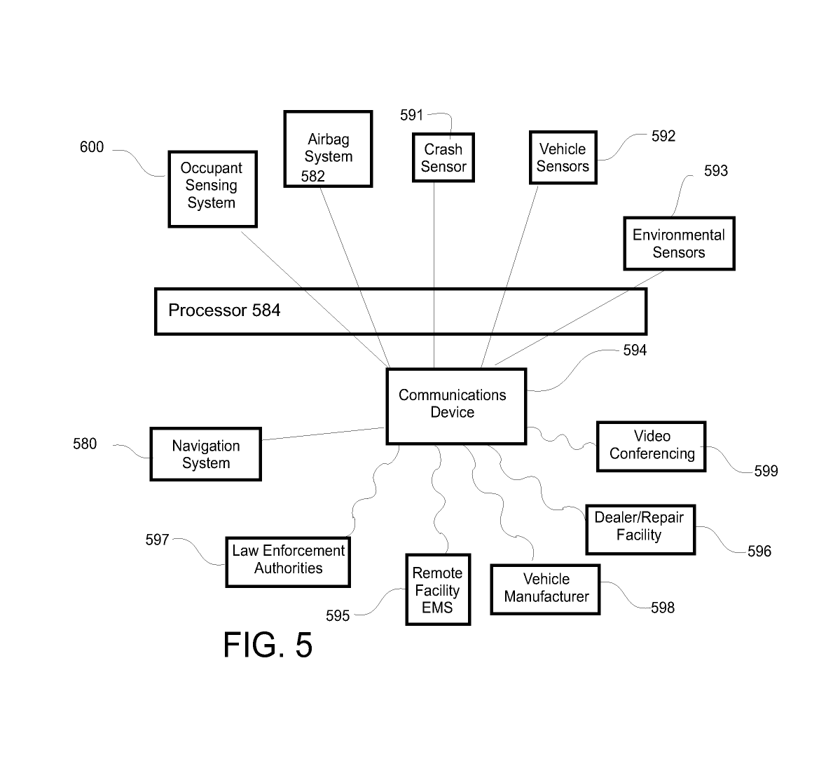

FIG. 5 shows a schematic of the integration of the occupant sensing with a telematics link and the vehicle diagnosis with a telematics link. As envisioned, the occupant sensing system 600 includes those sensors or other components which determine the presence, position, health state, and other information relating to the animate occupants, for example the transducers discussed with reference to FIGS. 1, 2 and 61 of the parent '363 application and the SAW device discussed with reference to FIG. 62 of the '363 application. Information relating to the occupants might include, by way of example, information as to what the driver is doing, talking on the phone, listening to the radio, or is sleeping, drunk, drugged, or is having a heart attack. The occupant sensing system may also be any of those systems and apparatus described in the current assignee's patents and patent applications or any other comparable occupant sensing system which performs any or all of the same functions as they relate to occupant sensing. Examples of sensors which might be installed on a vehicle and constitute the occupant sensing system include heartbeat sensors, motion sensors, weight sensors, one or more microphones and optical sensors.

The occupant sensing system 600 may be entirely integrated into the vehicle, such as installed during manufacture of the vehicle, or may be partly integrated into the vehicle and partly embodied in one or more components that are removable from the vehicle, and possibly usable as independent components when removed from the vehicle. For example, the occupant sensing system 600 may comprise a smartphone or other comparable telecommunications device that includes one or more sensors capable of obtaining information about any occupants of the vehicle when the smartphone is present in the vehicle. In an exemplifying embodiment, most smartphones include a microphone. A microphone records sounds that can be used to ascertain the presence of a particular number of occupants, based on for example, different voices being detected, or the condition of occupants after a crash. The microphone of a smartphone can therefore be used as part of the occupant sensing system 600 when the smartphone is present in the vehicle and coupled to the processor 584 and/or communications system 594. Sounds recorded by the smartphone would be processed and provided to the processor 584 and/or communications system 594 to be included in a data packet being directed from the communications system 594 to a remote facility.

A crash sensor system 591 is provided and determines when the vehicle experiences a crash or an accident to the extent different from a crash. This crash sensor system 591 may be part of the occupant restraint system or independent from it. Crash sensor system 591 may include any type of crash sensors, including one or more crash sensors of the same or different types.

The crash sensor system 591 may be entirely integrated into the vehicle, such as installed during manufacture of the vehicle, or may be partly integrated into the vehicle and partly embodied in one or more components that are removable from the vehicle, and possibly usable as independent components when removed from the vehicle. For example, the crash sensor system 591 may comprise a smartphone or other comparable telecommunications device that includes one or more sensors capable of obtaining information about its motion/acceleration when the smartphone is present in the vehicle, and preferably mounted on the vehicle. If a smartphone is provided with an inertial measurement unit (IMU), including one or more accelerometers, and preferably three accelerometers and three gyroscopes, it can effectively act as a crash sensor, detecting its acceleration which corresponds to the acceleration of the vehicle. The IMU of a smartphone can therefore be used as part of the crash sensor system 591 when the smartphone is present in the vehicle and coupled to the processor 584 and/or communications system 594.

Vehicle sensors 592 include sensors and sensor systems that detect the operating conditions of the vehicle such as those sensors and sensor systems discussed with reference to FIGS. 136-141 of the '881 application, or those that perform diagnostics for the vehicle and/or its components. Also included are tire sensors such as disclosed in U.S. Pat. No. 6,662,642. Other examples include velocity and acceleration sensors, and angle and angular rate pitch, roll and yaw sensors. Of particular importance are sensors that tell what the car is doing: speed, skidding, sliding, location, communicating with other cars or the infrastructure, etc. Thus, one of main vehicle sensors 592 may be a location or position determining system that determines the position of the vehicle, e.g., a GPS system.

Environment sensors 593 includes sensors which provide data to the operating environment of the vehicle, e.g., the inside and outside temperatures, the time of day, the location of the sun and lights, the locations of other vehicles, rain, snow, sleet, visibility (fog), general road condition information, pot holes, ice, snow cover, road visibility, assessment of traffic, video pictures of an accident, etc. Possible sensors include optical sensors (cameras) which obtain images of the environment surrounding the vehicle, blind spot detectors which provides data on the blind spot of the driver, automatic cruise control sensors that can provide images of vehicles in front of the host vehicle, various radar devices which provide the position of other vehicles and objects relative to the subject vehicle.

The occupant sensing system 600, crash sensor system 591, vehicle sensors 592, environment sensors 593 and all other sensors listed herein can be coupled to a communications system or device 594 which may contain or be associated with a memory unit and appropriate electrical hardware to communicate with the sensors, process data from the sensors, and transmit processed data derived from the data from the sensors in the form of a data packet to the remote facility. The memory unit would be useful to store data from the sensors, updated periodically, so that such information could be transmitted at set time intervals and/or when other conditions for transmission of a data packet are satisfied. Instead of being integrated into the communications system 594, the memory unit and related hardware and software may be integrated into the processor 584 discussed below.

The communications system 594 may be entirely integrated into the vehicle, such as installed during manufacture of the vehicle, or may be partly integrated into the vehicle and partly embodied in one or more components that are removable from the vehicle, and possibly usable as independent components when removed from the vehicle. For example, the communications system 594 may comprise a smartphone or other comparable telecommunications device that when present in the vehicle, is coupled to the occupant sensing system 600, crash sensor system 591, vehicle sensors 592, environment sensors 593 and all other sensors listed herein. This coupling may be via a wireless coupling and/or a wired coupling to an adapter on the vehicle.

The communications system 594 can be designed to transmit information to any number of different types of facilities. For example, the communications system 594 may be designed to transmit information to an emergency response facility 595 in the event of an accident involving the vehicle. The transmission of the information could be triggered by a signal from a crash sensor system 591 that the vehicle was experiencing a crash or experienced a crash. The information transmitted could come from the occupant sensing system 600 so that the emergency response could be tailored to the status of the occupants. For example, if the vehicle was determined to have ten occupants, multiple ambulances might be sent. Also, if the occupants are determined not be breathing by the occupant sensing system 600, then a higher priority call with living survivors might receive assistance first. As such, the information from the occupant sensing system 600 would be used to prioritize the duties and reactions of the emergency response personnel.

Information from the vehicle sensors 592 and environment sensors 593 can also be transmitted to law enforcement authorities 597 in the event of an accident so that the cause(s) of the accident could be determined. Such information can also include information from the occupant sensing system 600, which might reveal that the driver was talking on the phone, putting on make-up, or another distracting activity, information from the vehicle sensors 592 which might reveal a problem with the vehicle, and information from the environment sensors 593 which might reveal the existence of slippery roads, dense fog and the like.

Information from the occupant sensing system 600, vehicle sensors 592 and environment sensors 593 can also be transmitted to the vehicle manufacturer 598 in the event of an accident so that a determination can be made as to whether failure of a component of the vehicle caused or contributed to the cause of the accident. For example, the vehicle sensors might determine that the tire pressure was too low so that advice can be disseminated to avoid maintaining the tire pressure too low in order to avoid an accident. Information from the vehicle sensors 592 relating to component failure could be transmitted to a dealer/repair facility 596 which could schedule maintenance to correct the problem.

The communications system 594 can be designed to transmit particular information to each site, i.e., only information important to be considered by the personnel at that site. For example, the emergency response personnel have no need for the fact that the tire pressure was too low but such information is important to the law enforcement authorities 597 (for the possible purpose of issuing a recall of the tire and/or vehicle) and the vehicle manufacturer 598.

In one exemplifying use of the system shown in FIG. 5, the operator at the remote facility 595 could be notified when the vehicle experiences a crash, as detected by the crash sensor system 591 and transmitted to the remote facility 595 via the communications system 594, i.e., by receiving one or more data packets generated at the vehicle and transmitted using the communications system 594. At least one and maybe all of the received data packets includes information from one or more of the crash sensor system, 591, vehicle sensors 592, environmental sensors 593 and occupant sensing system 600. It is possible that each data packet contains a discrete subset of all of the available information so that all of the available information is obtained only by receiving multiple data packets.

If the vehicle occupants are unable to, or do not, initiate communications with the remote facility 595, the operator at the remote facility would be able to receive information from the occupant sensing system 600, as well as the vehicle sensors 592 and environmental sensors 593, by processing the received data packets. The operator could then direct the appropriate emergency response personnel to the vehicle. The communications system 594 could thus be designed to automatically establish the communications channel with the remote facility when the crash sensor system 591 determines that the vehicle has experienced a crash.

A provision may also be made to enable the operator at the remote facility 595 to initiate a request for specific information from one or more of the crash sensor system 591, vehicle sensor 592, environmental sensors 593 and occupant sensing system 600 if such information was not included in the received data packet(s). To this end, a computer program may reside in the communications system 594 and interpret a command from the remote facility for such information into a request to seek out the requested information from the appropriate sensor or sensing system or from memory in which the requested information is stored.

The communications system 594 can be a cellular phone, a peer-to-peer vehicle communication system that eventually communicates to available communications infrastructure and then, perhaps, to the Internet with e-mail to the dealer, manufacturer, vehicle owner, law enforcement authorities or others. It can also be a vehicle to LEO or Geostationary satellite system such as Skybitz which can then forward the information to the appropriate facility either directly or through the Internet. It can also be directly to a ubiquitous internet system such as WiMAX.

The communication may need to be secret so as not to violate the privacy of the occupants and thus encrypted communication may in many cases be required. Other innovations described herein include the transmission of any video data from a vehicle to another vehicle or to a facility remote from the vehicle by any means such as a telematics communication system, a cellular phone system, a communication via GEO, geocentric or other satellite system and any communication that communicates the results of a pattern recognition system analysis. Also, any communication from a vehicle that combines sensor information with location information is anticipated by at least one of the inventions disclosed herein.

An important aspect of some embodiments of the invention is that the operator at the remote facility 595 is contacted directly through the communications system 594, either through a vehicle resident phone system, a smartphone system, or directly to the Internet through an ISP or comparable system. The remote facility 595 is one that determines, based on the information provided by the vehicle's communications system 594, response personnel and equipment to dispatch to the site of the accident and that dispatches the appropriate personnel and equipment. For example, the remote facility 595 may be an emergency dispatch center operated by a municipality and that directly commands police, fire and emergency medical technicians (EMTs) to the accident site, i.e., the location provided by the communications system 594. The remote facility 595 is not a manned operations center of an emergency service, such as ONSTAR®, that has people and/or automated systems to process information from the vehicle and, in turn, contact the emergency dispatch center.

Thus, in this embodiment, a manual or automated intermediary is not required and once the vehicle owner has purchased the system, yearly or monthly payments are not necessary to fund the intermediary. That is, the presence of a human or computer-operator to receive information from the vehicle, process the invention and forward the processed information to another person or facility is not necessary. There is a direct connection or communications between the vehicle and the actual emergency operator at the remote facility 595 that will directly dispatch emergency personnel and/or equipment to the scene of an accident.

Accordingly, as used herein, an “intermediary” is considered to be a human or computer that is contacted by a vehicular communication system to receive information about an accident involving the vehicle and processes the received information and then forwards the processed information, for example, to an actual dispatch facility that will dispatch emergency personnel and possibly equipment.

Eliminating the intermediary does not adversely affect the effectiveness of the system because the intermediary, of conventional automatic crash notification systems, has no information that is not available on the properly equipped vehicle in accordance with the invention and thus only adds cost to the system. The system of this implementation would therefore talk directly to the EMS operator and provide all available information relative to the accident.

It is contemplated that the communications system 594 is capable of communicating with the remote facility, e.g., 911 dispatch center, directly without an intermediary, yet also capable of communicating with other remote facilities possibly through intermediate entities. In the latter case, the communications system 594 may be capable of effective vehicle-to-vehicle communications or vehicle-to-infrastructure communications of other information, e.g., information not arising from an accident or crash involving the vehicle.

To ensure that the EMS operator obtained the data packet or message containing the indication of a crash and ancillary information as described above, the data packet or message would be periodically repeated until the call is terminated by the EMS operator. Alternatively, a new data packet or message (updated with then-current information) is periodically generated and sent until the call is terminated by the EMS operator to account for changes in the information during the call.

The communications system 594 may be configured to generate or derive each data packet or message from data provided by one or more of the occupant sensing system 600, the crash sensors 591, the vehicle sensors 592, the environment sensors 593 and all other sensors listed herein. This message may be formatted in the same manner as 911 messages are formatted or in a unique format relative to a vehicular environment. For example, the format of the message may be to have the location in the largest font and prominent location, and then the number of people in the vehicle reporting the message and their condition. Secondary items of information such as the presence of carbon dioxide, fire, etc. may be less prominently displayed.

In one embodiment, the message generated by the communications system 594 results in the system transmitting at a minimum, the location or the GPS coordinates of the vehicle and additionally a verbal description of the location of the vehicle including, for example, the highway, the direction the vehicle was traveling prior to the accident, the distance to the previous and next exits, the milepost if available, and any other location-based information that might assist the EMS personnel in finding the vehicle. This could include the distance the vehicle traveled off the road after the accident as well as the direction of such post-accident travel.

To obtain this type of information, which will be referred to herein as secondary location information, information from a navigation system 580 in the vehicle may be used. The navigation system 580 may provide the highway the vehicle was travelling on, the direction the vehicle was travelling prior to the accident, and the distance to the previous and next exits based on information obtained from a map database. The milepost, if available, may also be provided by referring to the map database accessed by, include in or integrated into the navigation system.

To avoid the need to instantaneously generate this information, the navigation system 580 may be configured to update this information every second or so, possibly based on the speed of travel of the vehicle, and store the generated information. Then, in the event of a crash, the communications system 594 would access the memory of the navigation system 580 and retrieve the last stored set of information and transmit it to the remote facility.

Additional information which can be sent by the communications system 594 includes the number of airbags which deployed and which ones deployed, a measure such as the velocity change of the accident severity and the principle direction of force indicating the direction of the impact. This information may be derived from sensors that monitor the airbag system 582. The sensors of the airbag system 582 can provided the status of deployed and undeployed airbags. Any conventional airbag monitoring sensors may be used.

A provision can be made to allow the EMS operator at the remote facility 595 to orally communicate with occupants of the vehicle or if they are incapacitated to listen to any sounds emanating from the vehicle. Thus, the communications system 594 may be configured for bi-directional communications between the remote facility 595 and the vehicle.

If the system is appropriately configured, the sound of the accident and the airbag deployments may have been recorded by a microphone, which may be part of the occupant sensing system 600, and that sound can also be transmitted to the EMS operator with the message. The recorded sounds may be transmitted as an attached sound file with the message to the remote facility 585.

Other information in the message being transmitted by the communications system 594 to the remote facility 585 may include the number of the occupants and any evidence of their movement which could be obtained, for example, from pictures taken by any cameras that may be located within the vehicle. The cameras are one example of sensors included in the occupant sensing system 600. Additionally, the health state of one or more occupants can be transmitted if sensors such as heartbeat sensors are available.

Pattern recognition technology, e.g., neural networks, can also be employed to interpret the images of these cameras or other sensor output from sensors included in the occupant sensing system 600 on the vehicle prior to transmission by the communications system 594 to create an oral message for the EMS operator identifying the number of occupants and their post-crash motion or condition as well as their positions in the vehicle.

The pattern recognition system may be resident in a processor 584 that is interposed between the crash sensors 591, the vehicle sensors 592, the environment sensors 593, the occupant sensing system 600, and the airbag system 582 on one hand, and the communications system 594 on the other. Processor 584 may handle communications and signaling between the communications system 594 and the crash sensors 591, the vehicle sensors 592, the environment sensors 593, the occupant sensing system 600. It may also include a memory component in which data from the crash sensors 591, the vehicle sensors 592, the environment sensors 593, the occupant sensing system 600 is stored and retrievable upon command from the communications system 594.

All or only part of the crash sensor system 591, the vehicle sensors 592, the environmental sensors 593, the occupant sensing system 600, the navigation system 580, the airbag system 582, the processor 584 and the communications system 594 may be integrated into a common unit that is installed on the vehicle during its manufacture, i.e., original equipment. Alternatively, all of part of these components may be integrated into a single unit that is designed as an aftermarket product. The components to be included in the aftermarket product may be only those that are not already present on a vehicle, e.g., it does not have to include a crash sensor system. The aftermarket product is coupled to the main vehicle bus and performs the same functions as the original equipment.

When optical sensors are provided as part of the occupant sensing system 600, video conferencing becomes a possibility, whether or not the vehicle experiences a crash. That is, the occupants of the vehicle can engage in a video conference with people at another location 599 via establishment of a communications channel by the communications system 594.

The vehicle diagnostic system described above using a telematics link can transmit information from any type of sensors on the vehicle.

A system for notifying remote personnel, e.g., emergency response personnel, of an accident is described herein.

Using the any of the various communication systems described above, an automatic crash notification system can be built. The crash can be sensed by the airbag crash or rollover sensors or the deployment of the airbag event can be sensed to trigger the communication of the event. The system can be powered by the vehicle power or a battery can be used that has a very long life since the system would draw little current until the event. An advantage of a self-powered system is that it can be more easily retrofitted to existing vehicles. Additionally, a self-powered system would still operate on the loss of vehicle power which can happen during a crash. A small energy harvesting unit based on vibrations or light can be incorporated to overcome battery loss due to leakage and maintain the battery in a charged state for the life of the vehicle. This self-contained system can use a microphone, for example, to sense airbag deployment and thus the only wiring required would be to the communication system which also could be contained within the unit. In some cases, the unit can be on the vehicle safety bus where it could derive both power and crash information. In this latter case, a backup power supply in the form of a capacitor can be provided. The communication system can be any of those mentioned above including a satellite based system such as provided by SkyBitz, Inc., the cellular phone system or, preferably, a ubiquitous internet system such as WiMAX. Such a ubiquitous system is not yet in service but the inventor believes that the arguments for such a system are overwhelming and thus it will occur probably in time for the deployment of a universal automatic crash notification system as described herein.

Any or all of the information obtained from occupancy and other onboard sensors can be part of the information sent to the remote location via the communication or telematics system.

When the driver of a vehicle is using a cellular phone, the phone microphone frequently picks up other noise in the vehicle making it difficult for the other party to hear what is being said. This noise can be reduced if a directional microphone is used and directed toward the mouth of the driver. This is difficult to do since the position of driver's mouth varies significantly depending on such things as the size and seating position of the driver. By using the vehicle interior identification and monitoring system of at least one of the inventions disclosed herein, and through appropriate pattern recognition techniques, the location of the driver's head can be determined with sufficient accuracy even with ultrasonics to permit a directional microphone assembly to be sensitized to the direction of the mouth of the driver resulting in a clear reception of his voice. The use of directional speakers in a similar manner also improves the telephone system performance. In the extreme case of directionality, the techniques of hypersonic sound can be used. Such a system can also be used to permit effortless conversations between occupants of the front and rear seats. Such a system is shown in FIG. 40 of the parent '363 application, which is a system similar to that of FIG. 2 only using three ultrasonic transducers to determine the location of the driver's head and control the pointing direction of a microphone. Speaker is shown connected schematically to the phone system 34 completing the system.

One transducer can be placed high in the A-pillar, another transducer on the headliner and yet another transducer on the IP. Other locations are possible as discussed above. The three transducers are placed high in the vehicle passenger compartment so that the first returned signal is from the head. Temporal filtering is used to eliminate signals that are reflections from beyond the head and the determination of the head center location is then found by the approximate centroid of the head-returned signal. That is, once the location of the return signal centroid is found from the three received signals from transducers, the distance to that point is known for each of the transducers based on the time it takes the signal to travel from the head to each transducer. In this manner, by using the three transducers, all of which send and receive, plus an algorithm for finding the coordinates of the head center, using a processor, and through the use of known relationships between the location of the mouth and the head center, an estimate of the mouth location, and the ear locations, can be determined within a circle having a diameter of about five inches (13 cm). This is sufficiently accurate for a directional microphone to cover the mouth while excluding the majority of unwanted noise. Camera-based systems can be used to more accurately locate parts of the body such as the head.

The placement of multiple imagers in the vehicle, the use of a plastic electronics-based display plus telematics permits the occupants of the vehicle to engage in a video conference if desired. Until autonomous vehicles appear, it would be best if the driver did not participate.

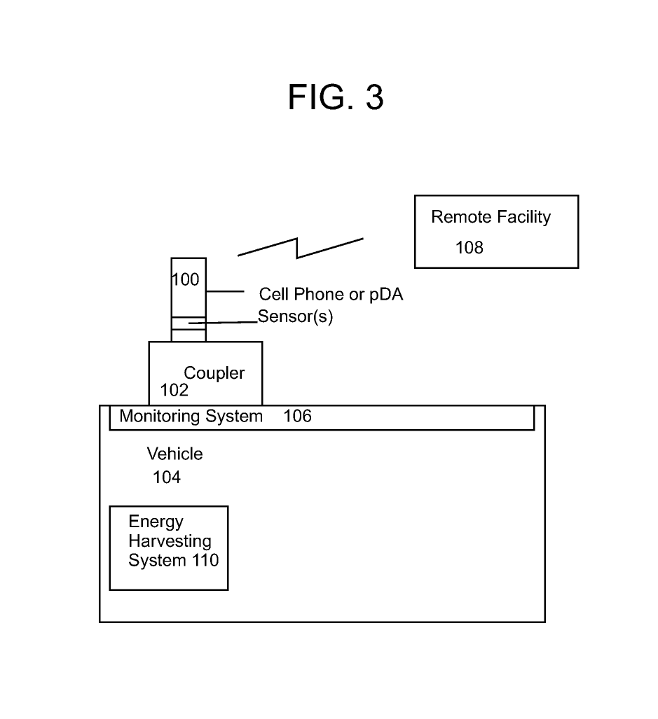

Referring now to FIG. 3, an alternate method of implementing the invention is to make use of a cell phone or PDA. Cell phones that are now sold contain a GPS-based location system as do many PDAs. Such a system along with minimal additional apparatus can be used to practice the teachings disclosed herein. In this case, the cell phone, PDA or similar portable device 100 could be mounted through a snap-in attachment system 102, for example, wherein the portable device 100 is firmly attached to the vehicle 104. The vehicle monitoring device 106 can at that point, for example, obtain a vehicular identification from the vehicle 104 through a variety of methods such as a RFID, SAW or hard-wired based system. It can also connect to a satellite antenna that would permit the vehicle monitoring device 106 to communicate to a LEO or GEO satellite system, such as Skybitz as described above. Since the portable device 100 would only operate on a low duty cycle, the battery should last for many days or perhaps longer. Of course, if it is connected to the vehicle power system, or to an energy harvesting system 110, its life could be indefinite. When power is waning, this fact can be sent to the satellite or cell phone system to alert the appropriate personnel at a remote facility 108. Since a cell phone 100 contains a microphone, it could be trained, using an appropriate pattern recognition system, to recognize the sound of an accident or the deployment of an airbag or similar event. The cell phone or PDA could be programmed to transmit a signal when it detects any of these noises, i.e., to a remote monitoring facility or emergency response facility 108. The remote facility 108 could then direct aid to the vehicle 104 once the position of the vehicle 104 is determined. The vehicle position determination may utilize the vehicular identification provided with the transmitted signal.

The cell phone or PDA 100 could also be used to provide information to enable an off-site computer, e.g., at a remote location, to determine the position of the cell phone and thus the vehicle 104 or other asset in which it is arranged. The cell phone would provide data about reception of signals, e.g., from satellites and/or other wireless beacons, and this data would be transmitted via the communications function of the cell phone or PDA 100 to the remote site. At the remote site, the position or location of the cell phone or PDA 100 (and vehicle 104) would be determined by performing, e.g., DGPS calculations.

As an alternative to using a satellite network, the cell phone network can be used in essentially the same manner when a cell phone signal is available. All of the sensors disclosed herein can either be incorporated into the portable device or placed on the vehicle and connected to the portable device when the device is attached to the vehicle. This system has a key advantage of avoiding obsolescence. With technology rapidly changing, the portable device can be exchanged for a later model or upgraded as needed or desired, keeping the overall system at the highest technical state. Existing telematics systems such as OnStar® can of course also be used with this system.

Importantly, an automatic emergency notification system can now be made available to all owners of appropriately configured cell phones, PDAs, or other similar portable devices that can operate on a very low cost basis without the need for a monthly subscription since they can be designed to operate only on an exception basis. Owners would pay only as they use the service. Stolen vehicle location, automatic notification in the event of a crash even with the transmission of a picture for camera-equipped devices is now possible. Automatic door unlocking can also be done by the device since it could transmit a signal to the vehicle, in a similar fashion as a keyless entry system, from either inside or outside the vehicle. The phone can be equipped with a biometric identification system such as fingerprint, voice print, facial or iris recognition etc. thereby giving that capability to vehicles. The device can thus become the general key to the vehicle or house, and can even open the garage door etc. If the cell phone is lost, its whereabouts can be instantly found since it has a GPS receiver and knows where it is. If it is stolen, it will become inoperable without the biometric identification from the owner.

Applying this embodiment of the invention, the cell phone or PDA can be used as an environment monitoring system for monitoring the environment in the vehicle, e.g., in the passenger compartment or interior space of a container. It could check for chemicals in the air in the passenger compartment or container. An energy harvesting system may be arranged in connection with the cell phone or PDA to generate energy to power the cell phone or PDA, or various sensors associated therewith, during movement of the vehicle.

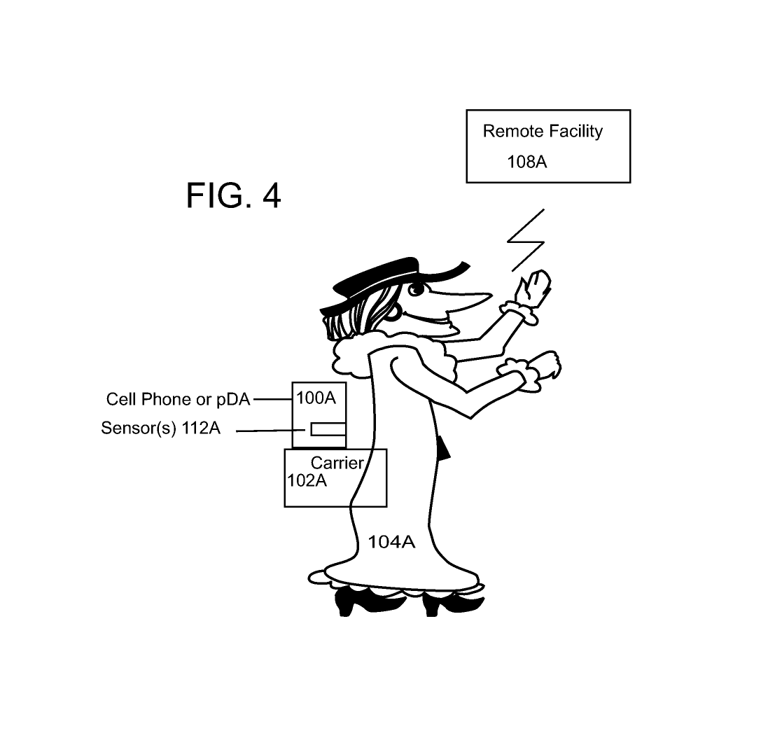

Referring now to FIG. 4, an alternate method of implementing the invention is to make use of a cell phone or PDA to monitor the person carrying the cell phone or PDA. In this case, the cell phone, PDA or similar portable device 100A is carried by the person 104A, for example, in their pocket, using a clip or in a holster or other carrying implement 102A. Since a cell phone, PDA or other similar portable device 100A typically contains a microphone, it could be trained, using an appropriate pattern recognition system, to recognize the sound of a reportable incident about the person, e.g., the person falling, the person calling for help. It thus becomes a very low cost “emergency alert” type system. The cell phone or PDA could be programmed to transmit a signal when it detects any of these incidents or noises, i.e., to a remote monitoring facility or emergency response facility 108A. The remote facility 108A could then direct aid to the person 104A once the position of the cell phone 100A is determined. Also, the cell phone, PDA or other similar portable device 100A may be programmed to take a picture when a reportable incident or noise is detected since the picture may provide information about the incident or the source of the noise.

It is important that the information obtained about the person 104A or the environment around the person 104A is not obtained by interaction with the person, i.e., the person does not manually enter the information using an input device such as a keyboard or manually take a picture of the environment. Rather, the portable device 100A is provided with one or more sensors 112A which automatically sense, detect or measure a property about the person, e.g., temperature, and/or the environment around the person, e.g., radioactivity level, and depending on the detection or measurement, transmit data to the remote facility 108A which receives and reacts to the information provided by the sensor(s) 112A, if desired and/or warranted. The thresholds of the sensed, detected or measured property to require a transmission may be varied and adjusted as desired, depending for example, on the person and/or on the environment.

The cell phone, PDA or other similar portable device 100A could also be used to provide information to enable an off-site computer, e.g., at the remote facility 108A, to determine the position of the cell phone and thus the person 104A or vehicle, building or other structure in which the person is located it is arranged. The cell phone would provide data about reception of signals, e.g., from satellites and/or other wireless beacons, and this data would be transmitted via the communications function of the cell phone, PDA or other similar portable device 100A to the remote site. At the remote site, the position or location of the cell phone, PDA or similar portable device 100A (and person 104A) would be determined by performing, e.g., DGPS calculations. For example, the portable device 100A may include a locating system arranged to obtain DGPS signals which are transmitted by a communications portion of the portable device 100A to the remote facility 108A to enable the location of the portable device 100A to be determined from the DGPS signals at the remote facility 108A.

As an alternative to using a satellite network, the cell phone network can be used in essentially the same manner when a cell phone signal is available. All of the sensors disclosed herein, e.g., a chemical sensor, can be incorporated into the portable device 100A and connected to the portable device when the device is carried by the person 104A. Thus, if the portable device 100A is provided with a radiation sensor, it can enable remote monitoring of the person's exposure to radiation.

The information provided by the portable device 100A, e.g., cell phone or PDA may be information about a person carrying the cell phone or PDA, derived from contact or proximity of the person to the sensor of the cell phone or PDA. A non-exclusive lists of sensors that may be arranged in association with the cell phone or PDA include one or more of a temperature sensor, radiation sensor, optical sensor, flow sensor, current sensor, voltage sensor, magnetic field sensor, electric field sensor, force sensor, charge sensor, viscosity sensor, density sensor, electrical resistance sensor, electrical impedance sensor, electrical capacitance sensor, electrical inductance sensor, humidity sensor, chemical sensor, biochemical sensor, biological sensor, acceleration sensor, velocity sensors, displacement sensor, location sensor, vibration sensor, acoustic sensor and pressure sensor.

In one implementation, the portable device 100A includes a processor which analyzes the information obtained by the sensor(s) 112A to determine whether the obtained information requires a transmission to the remote facility 108A and a communications portion arranged to transmit the obtained information or a signal representative thereof when the processor determines that the obtained information requires such a transmission. The processor and communications portion may be existing components of the portable device 100A, i.e., existing components of a cell phone or PDA which are programmed in accordance with the teachings herein. When a microphone is one of the sensors 112A, it receives sounds which are analyzed by the processor and possibly recognized by the processor, i.e., through training, to determine whether the received sounds are indicative of an accident or other reportable incident. In this case, the processor transmits an accident indication signal to the remote facility 108A via the communications portion, e.g., only when the sounds of an accident is recognized. More generally, the processor analyzes the obtained information from each sensor to determine whether the information satisfies a predetermined criteria requiring transmission of the information or a signal indicative thereof to the remote facility 108A and the communications portion is arranged to only transmit the obtained information when it satisfies one of the predetermined transmission criteria.

Other communication systems will also frequently be used to connect a container monitored as described above with the chassis and/or the tractor and perhaps the identification of the driver or operator. Thus, information can be available on the Internet showing what tractor, what trailer, what container and what driver is operating at a particular time, at a particular GPS location, on a particular roadway, with what particular container contents. Suitable security will be provided to ensure that this information is not freely available to the general public. Redundancy can be provided to prevent the destruction or any failure of a particular site from failing the system.

This communication between the various elements of the shipping system which are co-located (truck, trailer, container, container contents, driver etc.) can be connected through a wired or wireless bus such as the CAN bus. Also, an electrical system such as disclosed in U.S. Pat. No. 5,809,437, U.S. Pat. No. 6,175,787 and U.S. Pat. No. 6,326,704 can also be used in the invention.

Smartphones

In addition to the objects of the invention disclosed above and that are obtained by the structure disclosed above, another embodiment of the invention seeks to combine advantages of the vehicle with those of a smartphone to improve driving safety, security and experience of the vehicle operator.

In these embodiments, when a smartphone is brought into a vehicle, it will be connected to a vehicle bus via a coupling element (similar to snap-in attachment system 102 in FIG. 3), and the vehicle bus contains data from a variety of vehicle resident sensors and other peripherals including various actuators, antennas and displays. Preferably, the power and data connections will be accomplished wirelessly. For example, power can be transferred to the smartphone inductively and data by the Bluetooth or equivalent protocol. The term “peripheral” will be used herein to generally include all such vehicle resident sensors, actuators, antennas and displays. Sensors generally will refer to vehicle resident sensors; however, they can also include sensors brought into the vehicle such as occupant resident health monitoring sensors as well as smartphone resident sensors.

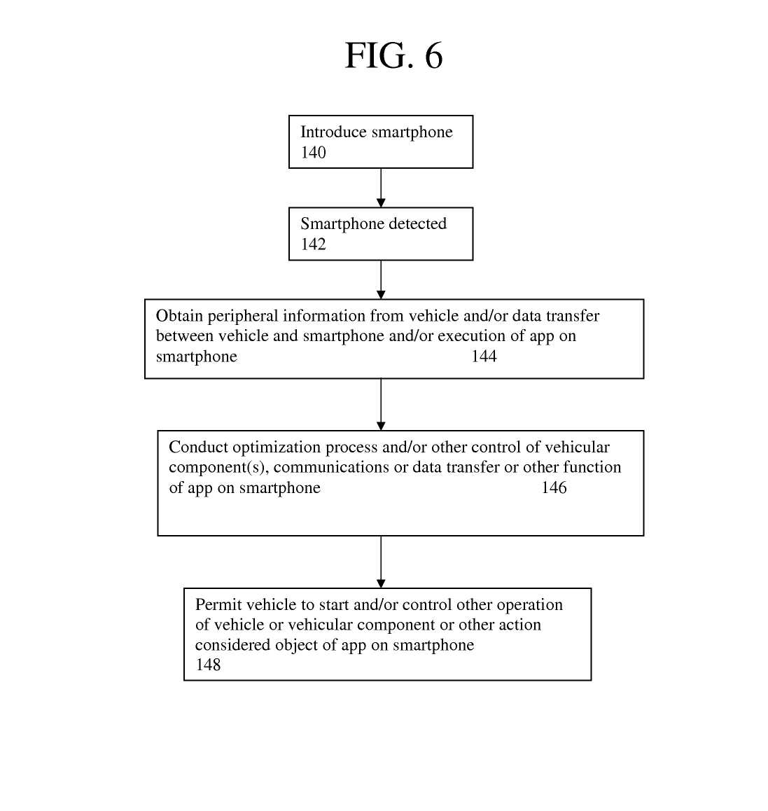

In general, any peripheral configuration can be accommodated and optimized by a smartphone since the drivers and other relevant information can be downloaded from the Internet in the same way that occurs when a new device is connected to a home computer. If the appropriate optimizing software is not resident on the smartphone, the optimization function can be done in the cloud. With satellite communication, internet access is ubiquitous so this process can occur anywhere on the continental United States. With reference to FIG. 6, when a new smartphone is introduced to a vehicle (140) and detected after coupling to the coupler element (142), the smartphone will obtain the peripheral information from the vehicle (144), conduct the optimization process (146) and then permit the vehicle to be started (148).

Again, since the smartphone is handled by the owner, it can verify biometrically the owner and eliminate security considerations. As such, ignition of the vehicle may be enabled when the smartphone is coupled to the vehicle via the coupling element by detecting the presence of identification or authorization information on the smartphone allowing for vehicle ignition.

A car may sit for months without being used and have obsolete software, thus, it cannot in general be the computing platform for the vehicle. On the other hand, if a smartphone is not present, the vehicle system can revert to the “as manufactured” system allowing the use of a conventional key etc. The absence of a smartphone coupled to the vehicle can be detected by a sensor (not shown) associated with the coupler element. If a smartphone is present, i.e., coupled to the coupler element and this coupling detected by a sensor or simply by virtue of initiation of data transfer between the smartphone and the vehicle (step 144 in FIG. 6), then it can assume many of the vehicle computational, communication and control functions. That is, the processor on the smartphone will undertake processing of data obtained by vehicle-resident peripherals (step 146 in FIG. 6).

The smartphone has and will have a computer, communications capability and the software to act as the vehicle computer replacing much of the existing vehicle resident computing system. The smartphone will also have limited sensor capabilities including a microphone and camera. The vehicle has and will have limited computational capabilities plus sensors that sense the vehicle, vehicle occupants and the environment. Some vehicle sensors such as cameras can be upgradable but generally they will not change during the vehicle life. In some cases, the vehicle owner will be able to add and or replace sensors that will not necessarily interface with vehicle resident systems.

The smartphone will interface with the vehicle sensor bus and thus have all of the vehicle sensor data available. Smartphone apps will recognize the hardware suite that is vehicle resident and analyze data from the vehicle sensors plus the smartphone sensors and communicate to the driver and remote sites including other vehicles. This can be used for collision avoidance (sending location and velocity data to nearby vehicles), occupant health monitoring, automatic collision notification, electronic tolling (to replace E-Z Pass, SunPass etc) and other functions. People will carry their cellphone much as they now do their wallet. The smartphone can have a biometric sensor to verify that the proper person is using it. When in the vehicle, it does one or more of the functions mentioned above while it is also being charged via a charging device associated with the coupling element. The smartphone can also control the vehicle displays such as the HUD.

A key advance of this invention is to add adaptability and flexibility to the vehicle and driving experience. It opens the vehicle to thousands of programmers who can develop apps for vehicles. When safety issues are involved, a licensing process may be necessary where the government or industry committee can ascertain that a new app does not degrade the vehicle safety system. The smartphone thus becomes the main telematics unit in the vehicle replacing such systems as GM OnStar® and Ford Sync.

The new system will affect, among other things, the safety, navigation, security, infotainment, vehicle diagnostics systems and location-based services.

Although smartphones primarily make use of cell phone towers for communication, there are times where the cell phone tower signal is not available or reliable and thus other communication channels are needed. In the case of the Ford Sync system, these channels are provided by the vehicle. Additionally or alternatively, in the invention, the channels can be provided by the vehicle and/or the smartphone. As various generations (e.g., LTE) of cell phone communication systems are implemented, a larger and larger percentage of the North America will be covered until such coverage is ubiquitous. In those areas where coverage is not available through terrestrial towers, satellite communication can now be used. Satellite communication requires greater power and is aided by larger antennas than are generally available in cell phones and thus such power and antennas can be provided by the vehicle. Other communication systems that can be used when available include WiMAX, WiFi hotspots and DSRC. DSRC is intended to consist of a family of transceivers located on the US federal highway system to improve vehicle-to-vehicle communication to reduce collisions. When DSRC is used, the antennas and transceivers can be located on the vehicle and, as in satellite communication, accessed by the smartphone through its connection with the vehicle.

Sensors that are currently resident on smartphones include one or more cameras, a microphone and various inertial sensors. To make effective use of these sensors, the mounting of the smartphone in the vehicle is important. The smartphone should be mounted such that the camera thereof has a clear view of the driver and the microphone can receive spoken words of the driver. These sensors can be supplemented by similar sensors that are vehicle resident in which case, the mounting of the smartphone is less important. If the smartphone is to be used for measuring vehicle motions such as would be present in a crash, for example, then again its mounting to the vehicle is important. Other sensors that can be present in the smartphone include a biometric sensor for user identification such as one that captures a fingerprint, facial image, iris image or other biometric property used for person recognition and identification.

Other sensors which may be on or used in conjunction with a smartphone include a breathalyzer or other alcohol sensor such as a sensor that measures the alcohol content in the blood near the skin, temperature sensor, humidity sensor, atmospheric chemical or radiation sensor and health monitoring sensors. For example, an alcohol sensor such as available from TruTouch Technologies can be incorporated into a smartphone and used to check for blood alcohol content before permitting a vehicle to be started. If a biometric identification can be accomplished by a modification of the same device through measuring blood vessel patterns, for example, then the system cannot be circumvented through a test on another person. This concept is also applicable for the TruTouch system now being tested by Takata under support from NHTSA for automobile starting systems. Of course many other sensors and sensor systems can be resident on a smartphone or positioned to communicate to the smartphone either wirelessly or by wires that are not attached to the vehicle.

The present invention also encompasses “apps” for smartphones that provide, for example, automatic collision notification for vehicles that are not so equipped. This capability can be leveraged to provide the software needed to drive the vehicle smartphone marriage to improve vehicle safety, security, navigation, diagnostics, infotainment and location-based services as discussed in more detail below. Such apps, for example, can pool the available peripherals on the vehicle, sensors on the smartphone, communication channels etc and configure a system that makes optimum use of the available devices and channels (see reference to apps in steps 144, 146 and 148 in FIG. 6). Thus, any smartphone can adapt itself to any vehicle that is equipped to interface to a smartphone. This configuration process need not be time consuming since there are only a relatively small number of such combinations and once configured, it can be stored in the smartphone and in the cloud to minimize configuration time in the future and for others. The apps can also take into account personal preferences such as seat position, vehicle temperature, minor positions and travel routes. As the apps improve to make better use of peripherals, for example, the software on the smartphone can be automatically updated in much the same way as new program versions automatically update software on personal computers.

Communication from the smartphone need not make use of only a single channel. When two vehicles are on a collision course, for example, all channels may not be available to all relevant vehicles. Thus, the vehicles can simultaneously broadcast their positions and velocities using a system similar to the ADS-B system of airplanes, establish an ad hoc network with vehicles in the vicinity, transmit to a DSRC transceiver or to the Internet thereby maximizing the chance that the information will be received by all relevant vehicles in time to prevent a collision.

Apps on the smartphone are expected to make significant use of voice recognition in much the same way as some high end vehicle do so now. This is particularly important in vehicles where texting or any manual manipulation of the phone can cause an accident. Of course, this will now be available to all vehicles that provide the smartphone interface regardless of their cost. The voice recognition software will also be far superior to that now offered on vehicles due to the larger development community. Such software can be expected to work in many languages and thus also to be able to translate between languages. Voice recognition can be supplemented by gesture recognition, as described in U.S. Pat. Appin. Publ. No. 20080065291, either to augment or supplement voice commands. The driver, for example, can say temperature and then give a thumb up to cause the vehicle to raise the interior temperature.

In general, the smartphone will be connected to the Internet when it is mounted in the vehicle. Thus, the vehicle or smartphone can also connect to a wireless router permitting other occupants of the vehicle to connect to the Internet for any desired purpose including providing TV shows and movies for occupants other than the driver.

The smartphone can also be used in place of a key to permit locking and unlocking of the vehicle doors and trunk and even opening of the doors to ease entry into the vehicle. When the vehicle is given to a parking lot attendant, the phone can permit vehicle operation according to some time or geographical constraints until the owner returns to retrieve the vehicle. A separate physical key can of course also be provided for such purposes. Naturally, the smartphone can now be also used for opening any locked door including homes, apartments, garages office, buildings etc.

As an example of how such a system can be used consider the case of a driver convicted of a DUI offense that must be able to drive in order to get to work. The alcohol sensor described above can communicate with a remote site. The remote site can verify that the identified driver uses the sensor and passes the blood alcohol test and then permit the vehicle to be driven. In another example, the smartphone or vehicle-resident camera finds the eyes of the driver and controls the position of images on a heads up display (HUD). In still another example, the software that analyzes the vehicle sensors can be more sophisticated than that currently in use and can not only diagnose that there is a vehicle mechanical or electrical problem (diagnostics) but can forecast that a problem will occur (prognostics) This forecast can be based not only on the sensor readings and trends in the readings but also based on the influence of the temperature of the environment around the vehicle and on the history of similar vehicles. This additional information can be obtained from the Internet.

Theft of cargo can also be reduced through the system described above by using the smartphone-based biometric identifying system to ascertain that the proper driver is about to operate the vehicle hauling the cargo. It can also be used to send SMS or equivalent messages on the status of the cargo and trailer as disclosed in U.S. provisional patent application Ser. Nos. 61/452,418 filed Mar. 14, 2011 and 61/508,822 filed Jul. 18, 2011. If the expected driver is not operating the vehicle or the expected SMS messages are not received, the vehicle can be disabled, reported stolen to local authorities or take any of the other measures as described in these provisional patent applications.

In another application, the system will know that the smartphone is in a vehicle and thus the vehicle can be used as a probe vehicle to obtain information with regard to traffic, weather conditions and in particular visibility which can then be used to set local speed limits. Other probe attainable information includes road conditions such as the existence and location of pot holes or ice, incidents such as the existence of a fallen tree or accident not involving the host vehicle and the environment such as the presence of airborne chemical vapors or radiation. Furthermore, the cloud-based system can know the status of all traffic lights and warn the driver if the vehicle is approaching a red light at an excessive speed. It can even automatically slow and stop the vehicle, thereby preventing many intersection collisions.

A key feature of the Onstar® system is the presence of live operators. With a generally available system that is not tied to a vehicle manufacturer, the possibility for competing and specialized live operators is not only reduced in cost but made far more useful and efficient. The smartphone can connect to different specialized operators based on the choice of the smartphone owner. Thus, an accident can connect the driver to his personal health care provider that knows his particular medical conditions and at the same time to emergency services so that responders can be optimally prepared. Insurance companies and/or automobile clubs such as AAA can be notified based on the preset preferences of the smartphone owner. Additionally, the gas station brand or restaurant type choice can be found based on the preferences of the smartphone owner rather than one size fits all as provided by Onstar®.

There are times where a private vehicle needs to assume emergency vehicle status when there is a medical emergency and time is critical for getting to a hospital, for example. In such a case, all similarly equipped vehicles as well as the local authorities can be notified so that that path to the hospital is cleared and even police escort provided. This can be accommodated either through an app or a live operator specializing in such acts as well as the vehicle-to-vehicle communication system described above.

Vehicle

The vehicle has many resident sensors that are currently used, generally individually, to diagnose various conditions relating to the vehicle and its components. As described in detail, for example, in U.S. Pat. No. 7,103,460, many of these sensors can be used in combination to perform prognostics to predict that a component will fail and to do so in time to prevent a failure. In some cases, a few sensors that are not currently in most vehicles can be added to significantly improve this process. A microphone, for example, can detect many sounds indicative of future component failures and yet such a sensor is not typically available for this purpose on most vehicles. A microphone is available on all smartphones and with the proper app can be used for this function. Additionally, microphones that are installed on a vehicle can be incorporated into a diagnostic system using a smartphone available app. Similarly, various inertial sensors (e.g., accelerometers, gyroscopes) that are resident on the vehicle and on the smartphone can contribute to diagnostics and prognostics through an app that can be made available to all smartphone owners.

Through the information available on the Internet, the smartphone can also advise the vehicle owner that there is a new better sensor available that can be substituted for an existing sensor as a vehicle hardware upgrade. Although this will probably not occur with great frequency, it nevertheless informs the vehicle owner about the availability of upgrades or even new hardware that can be readily added to the vehicle thus providing the ability to upgrade the capabilities of his or her vehicle.

Many vehicles now have various vision or radar-based sensors that sense objects such as pedestrians, animals, signs and other vehicles in the space surrounding the vehicle. The software needed to identify and/or categorize such objects can be sophisticated and expensive to develop. Thus, the software on one vehicle may be inferior to that on another and all such software will be grossly inferior to that that can be developed by the army of programmers willing to take on that task. For example, Automotive Technologies International, Inc. was able to attain 99.99% accuracy in vehicle occupant categorization using a single camera while a larger company using essentially the same hardware was only able to obtain about a 95% accuracy. By opening the development of such software to the software development community with the opportunity of selling smartphone apps, such highly accurate software can be made available to the public at large. The vehicle manufacturer would only need to make the data from such sensors available to the data bus for use by smartphone software developers.

An alcohol sensor such as under development by TruTouch described above, or as described in U.S. provisional patent application Ser. No. 61/452,469 and U.S. Pat. Appln. Publ. No. 20070025597 or in U.S. Pat. Nos. 6,793,242 and 7,768,380, can be vehicle-resident and can be analyzed by an app resident on the smartphone. Similarly, occupant sensors of various types including in particular an optical-based sensor intended to airbag suppression would be vehicle resident as would be the main software that analyzes the sensor output and controls the deployment of the airbags. This software is generally not changed once it is incorporated into the vehicle airbag system even though improvements may have been made. Also such software may be limited by the computer capabilities resident on the vehicle. Neither of these problems exists in a smartphone-based system thus permitting improvements to the safety systems of the vehicle. Additionally, newer occupant sensors may become available that can be retrofitted onto the vehicle. A fisheye type camera, for example, may become available that can be retrofitted and mounted onto the ceiling of the passenger compartment of the vehicle which not only accurately monitors both the driver and front seated passenger for airbag deployment control purposes, but can also serves other purposes such as monitoring for intruders into any part of the vehicle and determining the number of vehicle occupants and their injury state after an accident to aid emergency responders.

Naturally, the various crash, rollover, electronic stability control and other vehicle dynamics measuring sensors should be available on the data bus which connects to the smartphone for a variety of purposes including diagnostics, prognostics and automatic collision notification. The smartphone should be able to replicate the key fob functions so that the phone can be used to unlock and perhaps open one or more doors and the trunk and also to permit remote starting to warm up the vehicle in the winter, for example. Once the smartphone is properly attached to the vehicle, it can also be used to start the engine or the engine can start automatically with the mounting of the smartphone.

Health monitoring is becoming an increasingly important research topic in the vehicle safety community where the health of the driver is monitored and an alert or appropriate action is taken when safety considerations warrant. This is discussed in U.S. provisional patent application Ser. No. 61/452,469. In this invention, the health analysis is performed on the smartphone or, alternately, in a cloud based server. In this manner, improvements to the software can be automatically incorporated.

The ability to display the road edges and objects on or near the roadway onto a HUD is greatly augmented if the location of the eyes of the driver is known, as described in U.S. Pat. No. 7,860,626. Either the smartphone-resident camera or a camera mounted on the vehicle can be used for this purpose and the software to control the HUD projection or display system can reside in the smartphone for the reasons described above.

In addition to the safety restraint system, a number of the comfort and convenience systems that reside on the vehicle can be controlled from apps resident on the smartphone. These include the seat controls, HVAC controls and adjustable ride controls among others.

Although a GPS receiver will in general be resident on the smartphone, another GPS receiver can also be resident on the vehicle. The existence of two such receivers that are separated from each other allows the orientation of the vehicle to be determined and can assist in rollover detection if the two receivers are laterally displaced from each other.

Antennas for particular communication channels can also reside on the vehicle. This would in general be true for satellite communication due to the greater power requirements and to DSRC channels that may be dedicated for vehicles. The smartphone can still control the message that is sent using either of these systems.

Smartphone to Vehicle Interface

The smartphone requires power and access to sensor data and to the peripherals that are mounted on the vehicle. Although this can be accomplished through one or more wires, wireless connections are preferred for reliability considerations. The power can be supplied to the smartphone, for example, inductively through a coil provided on the vehicle and a mating coil in the smartphone. Capacitive power transfer is also possible but not as common. The connections to the data bus and to the peripherals can also be done wirelessly through a Wi-Fi, Bluetooth or similar system. Physically, the smartphone should be mounted so as to provide a clear view of the driver and allow for the microphone to clearly hear the words spoken by the driver. Of course, there may be some vehicles that have an appropriately placed camera and microphone such that the smartphone devices are not needed.

Enhancements

Many improvements and enhancements will now be evident to those skilled in the art. Two will be mentioned here.

Smartphones are now beginning to be used for making payments. Instead of giving a merchant cash or a credit card for a purchase, the funds can be immediately transferred from the smartphone owner's bank account to that of the merchant through a few keystrokes. The same concept can be used for the payment of tolls on a toll road. Without the need to obtain an E-Z Pass, Sunpass or equivalent, the information can be sent via any one of the communication channels on the vehicle. In fact, the trigger to send such a payment can be the passing of a GPS coordinate location thereby eliminating the need for toll stations at all, including the now being deployed high speed DSRC stations, thereby greatly reducing the cost of collecting tolls. Until that occurs, a generic DSRC antenna system can reside on the vehicle which is tuned to the particular system in use at the toll station. In E-Z Pass territory, it looks like an E-Z Pass and transfers the funds from the owner's account or a buffer account to the tolling authority.

Additional devices will become desirable for placement on a vehicle in order to aid in the interaction between the smartphone and the vehicle since the smartphone keypad or touch screen will not be available for use. Generally, the driver to smartphone interface will be by voice and gesture but for those cases where this is not practical, for example the driver has laryngitis, a touch pad can be made available on the steering wheel in conjunction with a HUD on the windshield. The driver can see the location of his fingers on the display and thus does not need to take his eyes off of the road.

Discussion of Some Fields of Use

Some of the fields of use of this technology will now be discussed.

Safety. The medical needs of each smartphone owner can either reside on his or her smartphone or in the cloud such that the operation of the vehicle can take into account any disabilities that the driver possesses. Similarly, as mentioned above, medical information can be made available to emergency responders before they leave for an accident so that the appropriate equipment is available at the accident scene. Similarly, if multiple occupants are in the vehicle during an accident all of their appropriate medical information can be made available as well as the number of occupants and perhaps the injury state of each.

Navigation. The navigation system can reside on the smartphone which, since it is generally connected to the Internet, will have updated maps. The display of points of interest and information related thereto in any degree of specificity can be provided and displayed on a vehicle display to improve the experience of tourists, for example. Traffic conditions will be known since all equipped vehicles can act as probe vehicles indicating the state of the traffic along the projected route. The navigation software can thus suggest alternate routes for the driver who is in a rush to reach his or her designation.

Security. Having a biometric identification system on the smartphone will prevent its unauthorized use by another. It will also make vehicle theft difficult. Monitoring of the status of the vehicle can determine whether there has been unauthorized entry and warn the owner before he or she approached the vehicle. If vision based sensors are resident on the vehicle, the smartphone owner can look inside his or her vehicle from a distance to detect any unauthorized occupant. Even the location of the vehicle in a mall parking lot can be easily determined by the appropriate app that remembers the GPS coordinates of the vehicle when the cell phone was removed.

Infotainment. The smartphone will be used for many purposes other than its interfacing to a vehicle. Thus, in most cases, the entertainment preferences of the driver will reside on the smartphone. This can include podcasts, audio books, music, radio stations and for other vehicle occupants video content including TV shows, movies etc. No special arrangement needs to be done to bring this infotainment content to the vehicle thus simplifying this process.

Location-Based services. Most people have a preferred brand of gas, or the least expensive brand, for their vehicle and a preferred restaurant type. This information will also generally be resident on the smartphone and when the gas gage in approaching empty the appropriate app can direct the driver to the appropriate gas station. This may in fact be the station with the cheapest gas in the area which the app will also know from Internet posted prices. Similarly, the driver can be directed to the closest Wendy's, if that is his or her choice, at mealtime.

Although several preferred embodiments are illustrated and described above, there are possible combinations using other geometries, sensors, materials and different dimensions for the components that perform the same functions. At least one of the inventions disclosed herein is not limited to the above embodiments and should be determined by the following claims. There are also numerous additional applications in addition to those described above. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention which is limited only by the following claims.

1. A method for notifying a remote facility of an accident involving a vehicle, the remote facility being a facility that determines response personnel and equipment to dispatch to the site of the accident and that dispatches the appropriate personnel and equipment, the method comprising:
obtaining information about the accident using a crash sensor system on the vehicle;
obtaining information about position of the vehicle using a position determining system;
obtaining information about occupancy of the vehicle by animate occupants using an occupant sensing system on the vehicle;
generating at least one data packet derived from information obtained by the crash sensor system and information obtained by the occupant sensing system;
directing the at least one data packet, using a communications system on the vehicle, from the vehicle directly to the remote facility without involving an intermediary; and
providing the information about position of the vehicle obtained by the position determining system to the remote facility to be associated with the at least one data packet.

2. The method of claim 1, further comprising integrating the crash sensor system, the occupant sensing system and the communications system into a single unit, further comprising installing the unit onto the vehicle during manufacture of the vehicle.

3. The method of claim 1, further comprising integrating the crash sensor system, the occupant sensing and the communications system into a single unit, further comprising installing the unit onto the vehicle as an aftermarket product installed after manufacture of the vehicle.

4. The method of claim 1, further comprising establishing a bi-directional communications channel for voice between the vehicle and the remote facility using the communications system.

5. The method of claim 1, wherein the occupant sensing system comprises at least one microphone, the step of obtaining information about occupancy of the vehicle by animate occupants using the occupant sensing system comprising recording sounds using the at least one microphone in the vehicle, the at least one data packet being generated to including sounds recorded by the at least one microphone.

6. The method of claim 1, further comprising repeating directing of the at least one data packet or a subsequently generated data packet until reception of the data packet by the remote facility is acknowledged.

7. The method of claim 1, wherein the position determining system is arranged on the vehicle, the step of generating the at least one data packet comprising including the position of the vehicle determined by the position determining system in the at least one data packet.

8. The method of claim 1, further comprising obtaining secondary location information from a navigation system on the vehicle, the step of generating the at least one data packet comprising including the secondary position information obtained from the navigation system in the at least one data packet.

9. The method of claim 8, further comprising configuring the navigation system to update the secondary position information at periodic time intervals, store the most recent secondary position information and then provide the stored most recent secondary position information to be included in the at least one data packet.

10. The method of claim 1, further comprising obtaining information about airbag deployment from an airbag system, the step of generating the at least one data packet comprising including the airbag deployment information obtained from the airbag system in the at least one data packet.

11. The method of claim 1, further comprising providing the information about the accident from the crash sensor system, the information about position of the vehicle from the position determining system, and the information about occupancy of the vehicle from the occupant sensing system to a processor, the processor being configured to generate the at least one data packet from the provided information.

12. The method of claim 1, wherein the step of obtaining information about occupancy of the vehicle by animate occupants using an occupant sensing system on the vehicle comprises obtaining information from a sensor on a telecommunications device present in the vehicle, the telecommunications device being removable from the vehicle and usable as a telecommunications device when removed from the vehicle.

13. A vehicular system for notifying a remote facility of an accident involving the vehicle, the remote facility being a facility that determines response personnel and equipment to dispatch to the site of the accident and that dispatches the appropriate personnel and equipment, the system comprising:
a crash sensor system that obtains information about the accident;
a position determining system that obtains information about position of the vehicle;
an occupant sensing system in the vehicle that obtains information about occupancy of the vehicle by animate occupants; and
a communications system that directs at least one data packet derived from the information obtained by said crash sensor system, the information obtained by said position determining system and the information obtained by said occupant sensing system from the vehicle directly to the remote facility without involving an intermediary.

14. The system of claim 13, wherein said communications system is configured to establish a bi-directional communications channel for voice between the vehicle and the remote facility.

15. The system of claim 13, wherein said occupant sensing system comprises at least one microphone that records sounds, said communications system being coupled to said at least one microphone, the sounds recorded by said at least one microphone being included in the at least one data packet.

16. The system of claim 13, further comprising a navigation system configured to obtain secondary position information, said communications system being coupled to said navigation system, the secondary position information obtained by said navigation system being included in the at least one data packet.

17. The system of claim 16, wherein said navigation system is configured to update the secondary position information at periodic time intervals, store the most recent secondary position information and then provide the stored most recent secondary position information to be included in the at least one data packet.

18. The system of claim 13, further comprising an airbag system that obtains information about airbag deployment, said communications system being coupled to said airbag system, the airbag deployment information obtained by said airbag system being included in the at least one data packet.

19. The system of claim 13, further comprising a processor coupled to said communications system, of said crash sensor system, said position determining system and said occupant sensing system, said processor being configured to generate the at least one data packet from the provided information.

20. A vehicular system for notifying a remote facility of an accident involving the vehicle, the remote facility being a facility that determines response personnel and equipment to dispatch to the site of the accident and that dispatches the appropriate personnel and equipment, the system comprising:
a crash sensor system that obtains information about the accident;
a position determining system that obtains information about position of the vehicle;
an occupant sensing system in the vehicle that obtains information about occupancy of the vehicle by animate occupants;
a navigation system configured to obtain secondary position information, said communications system being coupled to said navigation system;
an airbag system that obtains information about airbag deployment;
a communications system that directs at least one data packet to the remote facility without involving an intermediary, said communications system being configured to establish a bi-directional communications channel for voice between the vehicle and the remote facility; and
a processor coupled to said communications system, said crash sensor system, said position determining system, said occupant sensing system, said navigation system and said airbag system, said processor being configured to generate the at least one data packet from the information obtained by said crash sensor system, the information obtained by said position determining system, the information obtained by said occupant sensing system, the secondary position information obtained by said navigation system and the airbag deployment information obtained by said airbag system.
